(19) United States
(12) Patent Application Publication
(10) Pub. No.: US 2026/0181469 A1
(43) Pub. Date: Jun. 25, 2026

(54) METHODS, APPARATUSES AND SYSTEMS FOR TRANSPORT BLOCK CONSTRUCTION

(71) Applicant: InterDigital Patent Holdings, Inc., Wilmington, DE (US)

(72) Inventors: Faris Alfarhan, Montreal (CA); Paul Marinier, Brossard (CA); Samuli Turtinen, Ii (FI); Tuong Hoang, Montreal (CA); Ghyslain Pelletier, Montreal (CA)

(21) Appl. No.: 18/990,631

(22) Filed: Dec. 20, 2024

(51) Int. Cl. H04W 28/02; H04W 72/1268; H04W 88/02

(52) U.S. Cl. CPC H04W 28/0278; H04W 72/1268; H04W 88/02

(57) ABSTRACT

A wireless transmit/receive unit (WTRU) in communication with a wireless network includes a processor and a transceiver. The WTRU transmits, to the wireless network, a transport block (TB) construction assumption, where the TB construction assumption is associated with uplink (UL) data that is to arrive at the WTRU. The WTRU processes a TB based on the TB construction assumption, receives a UL grant for the TB, determines that an assumption signaled in the UL grant matches the TB construction assumption, and transmits the TB to the wireless network using the UL grant. Upon a failure to determine that the assumption signaled in the UL grant matches the TB construction, the WTRU may divide a resource allocation of the UL grant proportional to at least one of a prioritized bit rate, an amount of data bits in a traffic shaping bucket of the WTRU, buffered data levels, or data flow priorities.

### TECHNICAL FIELD

The present disclosure is generally directed to the fields of communications, software and encoding, including, for example, to methods, apparatuses, systems related to transport block construction, including but not limited to preprocessed traffic bucket construction.

### SUMMARY

A wireless transmit/receive unit (WTRU) may use a transport block (TB) to communicate with a wireless network. The TB may be constructed shortly before (and possibly immediately before) it is needed by the WTRU. To improve efficiency and processing at the WTRU, methods, apparatuses, and systems are provided herein for preprocessing (e.g., constructing before it is explicitly needed) a TB. The preprocessing is based on at least one TB construction assumption, where the assumption may include a transport block size (TBS), a quality of service (QoS) indicator, or any other suitable information. The WTRU transmits the TB construction to the wireless network (e.g., where the wireless network may be configured to match a TB to the TB construction). The preprocessing may occur before receiving an uplink (UL) grant from the wireless network, or in response to receiving a UL grant (or an initial status report) from the wireless network. The WTRU processes (i.e., constructs) the TB and then determines whether a signal of the UL grant matches the TB construction assumption. If the assumption is matched, then the WTRU transmits the TB to the wireless network using the UL grant. If not, then the WTRU may divide a resource allocation of the UL grant to maintain efficiency over processing the TB shortly before it is needed.

In accordance embodiments of the subject matter of this disclosure, methods, apparatuses (e.g., WTRUs), and systems are provided for transport block construction. In some embodiments, a WTRU in communication with a wireless network includes a processor and a transceiver. The WTRU transmits, to the wireless network, a transport block (TB) construction assumption, where the TB construction assumption is associated with uplink (UL) data that is to arrive at the WTRU. The WTRU processes a TB based on the TB construction assumption, receives a UL grant for the TB, determines that an assumption signaled in the UL grant matches the TB construction assumption, and transmits the TB to the wireless network using the UL grant. Upon a failure to determine that the assumption signaled in the UL grant matches the TB construction, the WTRU may divide a resource allocation of the UL grant proportional to at least one of a prioritized bit rate, an amount of data bits in a traffic shaping bucket of the WTRU, buffered data levels, or data flow priorities.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system according to some embodiments of this disclosure;

FIG. 1B is a system diagram illustrating an example wireless transmit/receive unit (WTRU) that may be used within the communications system illustrated in FIG. 1A according to some embodiments of this disclosure;

FIG. 1C is a system diagram illustrating an example radio access network (RAN) and an example core network (CN) that may be used within the communications system illustrated in FIG. 1A according to some embodiments of this disclosure;

FIG. 1D is a system diagram illustrating a further example RAN and a further example CN that may be used within the communications system illustrated in FIG. 1A according to some embodiments of this disclosure;

FIG. 2 shows an illustrative uplink transmission scheme and an illustrative transmission timing diagram according to some embodiments of this disclosure;

FIG. 3 shows an illustrative bit traffic timing diagram according to some embodiments of this disclosure;

FIG. 4 shows an illustrative envelope for shaping of data traffic according to some embodiments of this disclosure;

FIG. 5 shows an illustrative traffic shaping regulator according to some embodiments of this disclosure;

FIG. 6 shows an illustrative constrained traffic shaping regulator according to some embodiments of this disclosure;

FIG. 7 shows an illustrative RAN data plane architecture according to some embodiments of this disclosure;

FIG. 8 shows an illustrative timing diagram for TB construction according to some embodiments of this disclosure; and

FIG. 9 is a flowchart of illustrative steps for TB construction according to one or more embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

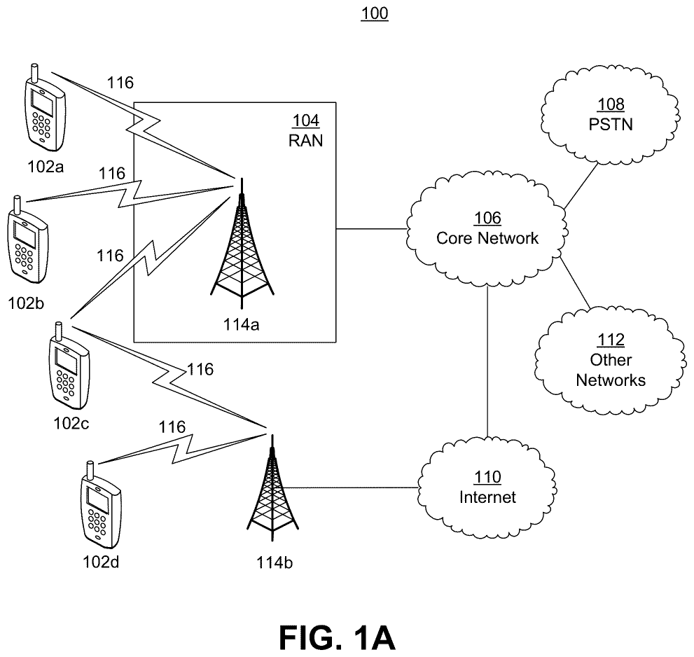

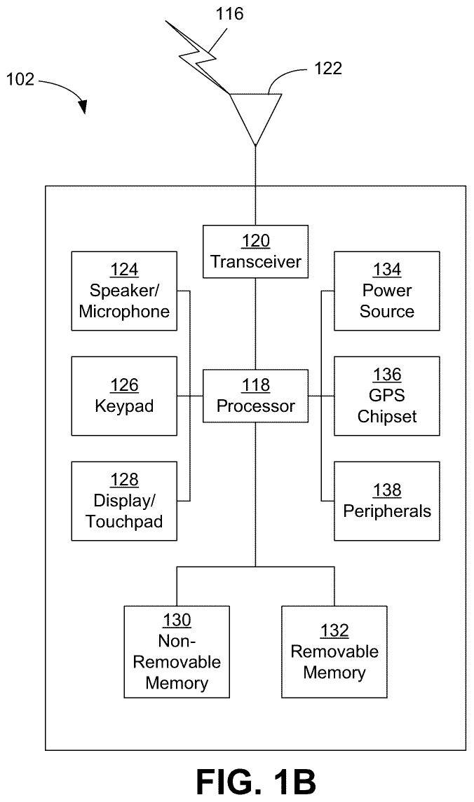

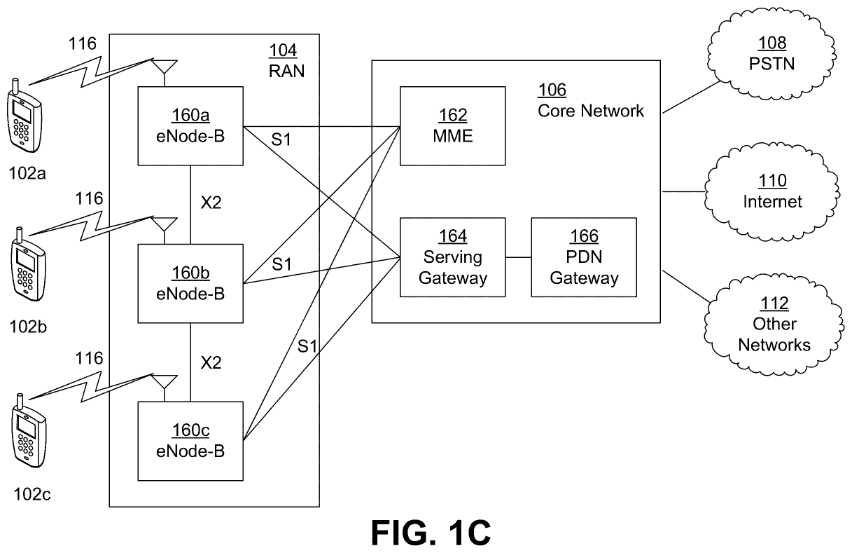

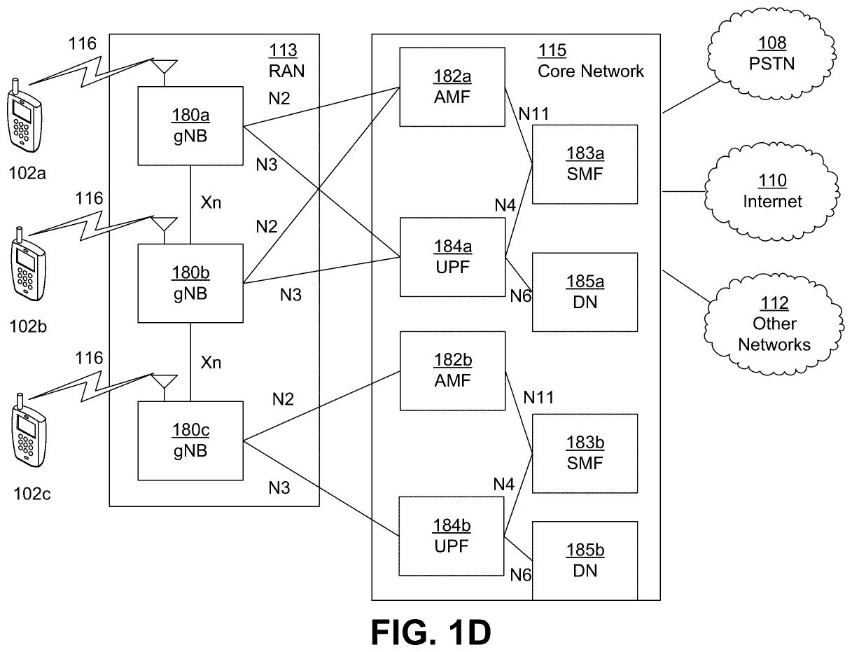

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) one or more user equipment (UE) components, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, and vice versa, e.g., if the WTRU includes only one active UE.

As used herein, a sensing device may refer to any device that can perform sensing based on a wireless signal, including but not limited to any of the WTRUs 102a, 102b, 102c and 102d, any UE, any base station (e.g., base station 114a of RAN 104, or base station 114b), any suitable eNode-B (e.g., any eNode-B 160a, 160b, or 160c), any suitable gNode-B (e.g., any gNode-B 180a, 180b, or 180c), any hardware of a core network (e.g., hardware configured to execute any access and mobility function (AMF), user plane function (UPF), session management function (SMF) or data network (DN) of a core network), or any other suitable device. In this disclosure, a sensing device may be interchangeably referred to as a sensor, a sensor node, or a sensing node.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b need not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment. It will be appreciated that the WTRU 102 may include multiple iterations of any the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

As mentioned, although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode need not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards UPFs 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one SMF 183a, 183b, and at least one DN 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The MME 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

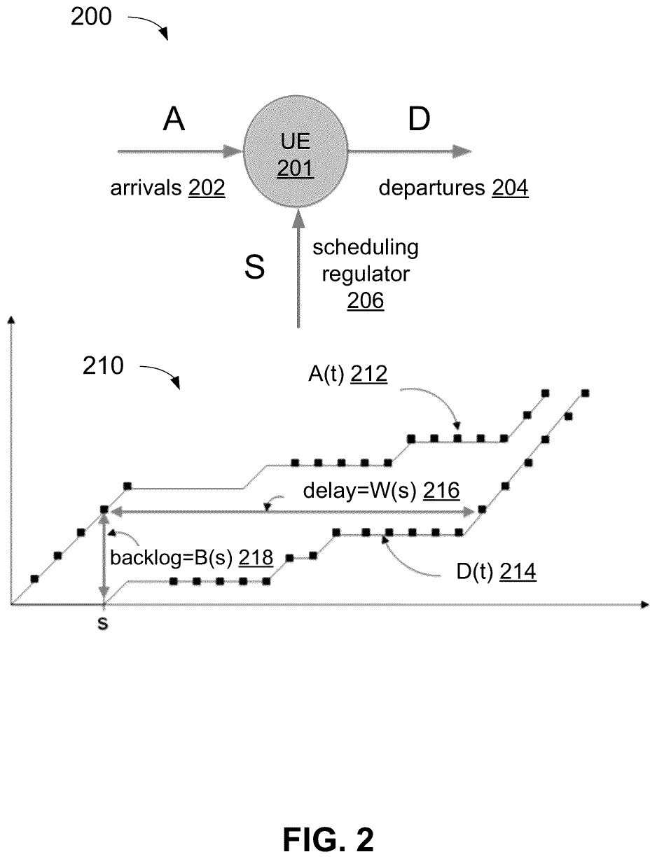

In accordance with some embodiments of this disclosure, the devices and systems of FIGS. 1A-1D may be used in connection with devices, systems, and methods for sensor reconfiguration. For example, in some embodiments of this disclosure, the devices and systems of FIGS. 1A-1D may be used in connection with the devices, systems, and methods described in FIGS. 2-9.

In accordance with some embodiments of this disclosure, an illustrative uplink transmission scheme and an illustrative transmission timing diagram is shown in FIG. 2 and described as follows. Illustrative scheme 200 shows a WTRU 201 (e.g., any WTRU 102) configured to receive data through arrivals 202 and send data through departures 204. Scheduling regulator 206 may govern a timing associated with receiving arrivals (A) 202 and/or transmitting departures (D) 204. During uplink transmission, the scheduling regulator(S) 206 can be used to characterize traffic transmission rates at WTRU 201. Scheduling regulator 206 may determine the worst-case bounds on delay and backlog in the WTRU's buffer. In FIG. 2, where A may describe the cumulative arrival function of traffic for a given flow to the WTRU's buffer and D may describe the transmission departure function from the WTRU's buffer to a scheduled grant. Illustrative timing diagram 210 could be associated with illustrative scheme 200. In some embodiments, the arrival function A(t) 212 may correspond to arrivals 202, and the departure function D(t) 214 may correspond to departures 204. A delay function, W(s) 216, characterizes the delay between when data arrives and when data is transmitted. At any condition s, there is a backlog that is characterized by backlog function b(s) 218. The backlog corresponds to how far behind (e.g., in unit intervals, or in absolute or relative time) data of the departure function is with respect to data of the arrival function.

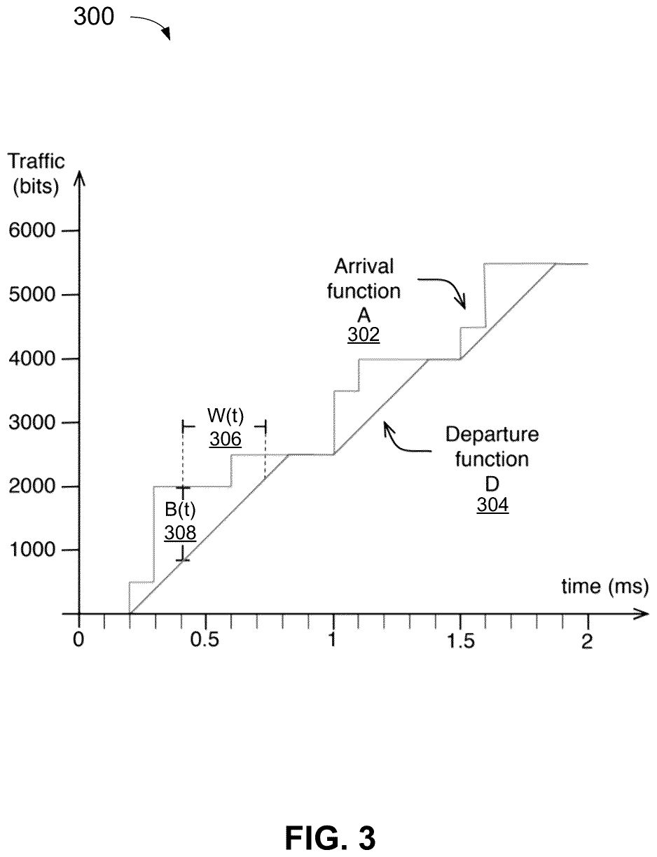

In accordance with some embodiments of this disclosure, an illustrative bit traffic timing diagram is shown in FIG. 3 and described as follows. In some embodiments, arrival function 302 may correspond to arrival function 212, departure function 304 may correspond to departure function 214, delay function 306 may correspond to delay function 216, and backlog function 308 may correspond to backlog function 218. Further, timing diagram 300 may correspond to timing diagram 210. Timing diagram 300 shows how stepwise increments in traffic (e.g., as measured in bits) at the arrival function 302 may cause linear flows of traffic at the departure function 304. Again, comparison of arrival function 302 and departure function 304 may yield delay function 306, which describes the time between when a bit arrives and when a bit departs, and may further yield backlog function 308, which describes the amount of bits being buffered to transition from the arrival function 302 to the departure function 304.

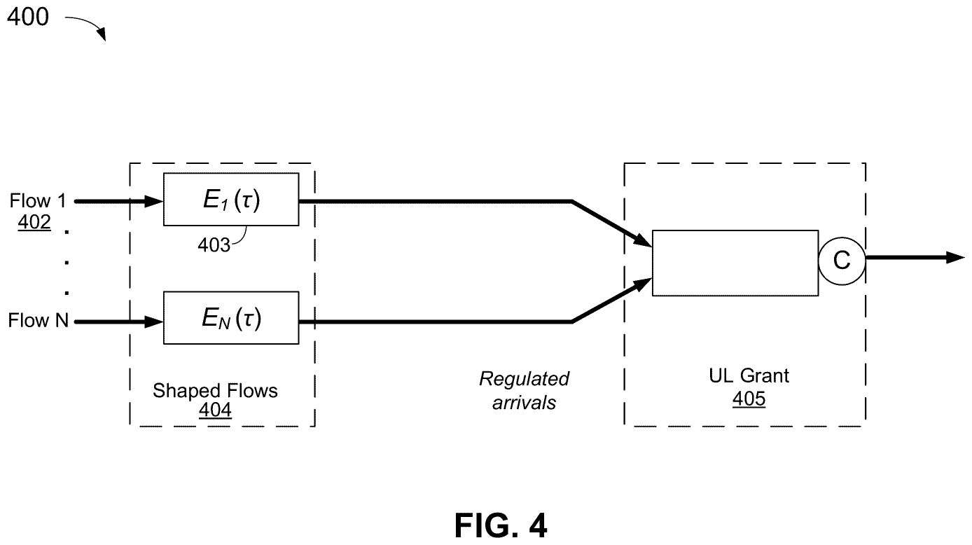

In accordance with some embodiments of this disclosure, envelope shaping of data traffic is shown in FIG. 4 and described as follows. Each data flow, such as flow 1 402, may compete for resources on a given uplink grant and may be shaped by an envelope “E”, such as envelope 1 403, which is denoted according to the function E₁(τ). Respective envelopes E₁-E_{N}, where N is any suitable integer, generate shaped flows 404 of data. The shaped flows 404 cause there to be regulated arrivals of data at UL grant 405. Upon being processed by an envelope, the data may be transformed as E(t-s)>=A(s,t), as shown in FIG. 4. In some embodiments, a traffic shaper (e.g., envelope 1 403) is a scheduling implementation which enforces that departing UL traffic complies with a given traffic envelope based at least in part on buffering non-compliant traffic. In FIG. 4, there may be N data flows competing for UL resources on a single UL grant 405 of size C, where C may be any suitably sized data allocation.

When processing network traffic, some illustrative and non-limiting reasons to shape traffic for a given data flow include that an operator may want to enforce that traffic from and to a given data flow complies to the subscribed data rate, or that video streaming over a cellular network may require matching the rate of video streams to the available capacity of an RF link.

Such processing (e.g., regulation) of network traffic may be referred to as traffic shaping or as traffic smoothing. Accordingly, transmitted traffic may be classified as shaped/compliant traffic, including traffic that satisfies a given traffic specification (e.g. traffic served in with the bounds of the traffic departure envelope), or non-shaped traffic, including traffic allocated to a grant and exceeding the traffic shaper (e.g., when modeled using a leaky-bucket algorithm, the traffic may cause the water level to exceed traffic shaping bucket). Non-shaped traffic may be considered as lower priority or best-effort priority, and may be buffered if it is not instantly transmitted.

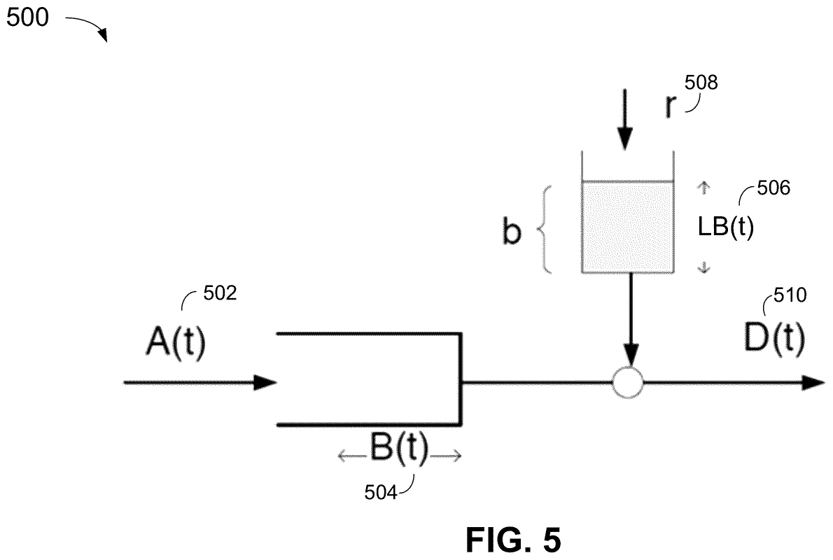

In accordance with some embodiments of this disclosure, an illustrative traffic shaping regulator is shown in FIG. 5 and described as follows. The illustrative regulator of FIG. 5 implements the leaky bucket algorithm, as shown, to regulate traffic. The bucket is filled with fluid (e.g., where the fluid corresponds to an amount of data that is trafficked) up to the indicated level (e.g., where the level indicates a resource allocation), where LB(t) indicates the filling level of the bucket at time t. Function A(t) 502 may correspond to arrival function 212, function B(t) 504 may correspond to backlog function 218, and function D(t) 510 may correspond to departure function 214. The leaky bucket, which is depicted and described by function LB(t) 506, enforces an envelope of the form E(t)=b+rt, where b is the maximum burst size (e.g., which helps to characterize bursty traffic), and r 508 is the long-term traffic rate (e.g., which may be set as the statistical average of the traffic transmission rate requirement). Initially, the bucket is set to LB(0)=b, which is referred to as a full bucket. The bucket is filled with fluid at a rate r 508 (e.g., and the data represented by the fluid is buffered at B(t) 504), however, nothing is added when the bucket is full. The content of the bucket LB(t) corresponds to the maximum amount of traffic that can be transmitted at the time of transport block (TB) construction (which may be based on the assumption that sufficient space is available for this construction). For each transmission of a service data unit (SDU), the content of the leaky bucket is reduced by the size of the SDU. When LB(t)=0, the bucket is empty, and no traffic can be transmitted. Traffic arrivals to an empty bucket are stored in the buffer and traffic in the buffer is transmitted at the filling rate r 508.

The logical channel prioritization (LCP) algorithm, which is used for uplink (UL) TB construction in LTE and NR is an example of a leaky bucket implementation. The LCP “Bj” term essentially describes a leaky bucket that enforces traffic to comply to a long-term rate (given by a prioritized bit rate (PBR) and a bucket size duration (BSD), such that the total long-term rate equals PBR*BSD). The LCP leaky bucket enforces an envelope of the form: E(s)=b+PBR*s; where b is 0 and PBR is the long-term traffic rate (e.g. set as the statistical average of the traffic transmission rate requirement). The LCP bucket thus enforces an envelope of the form: E(s)=PBR*s.

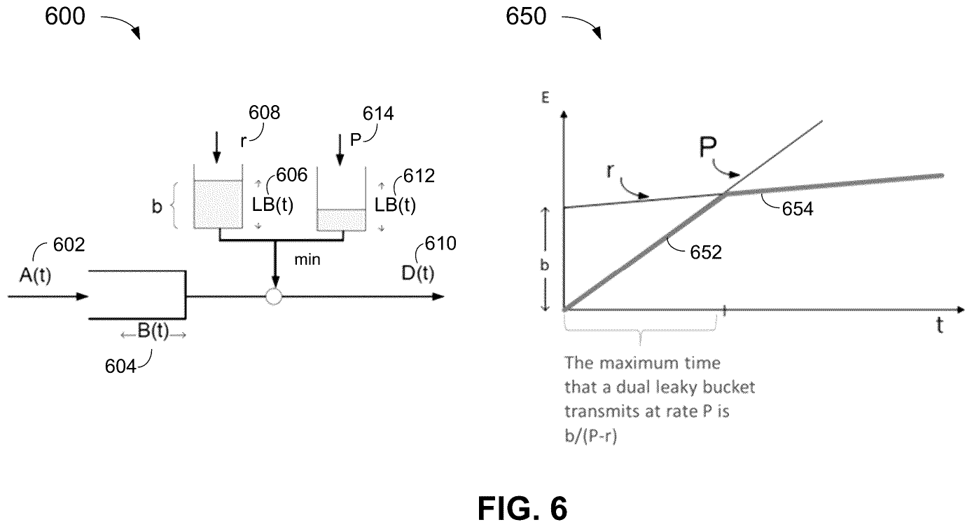

In accordance with some embodiments of this disclosure, an illustrative constrained traffic shaping regulator is shown in FIG. 6 and described as follows. The constrained traffic shaping regulator, which may be referred to as the dual leaky bucket or the peak-rate constrained leaky bucket, is a variation of the typical leaky bucket. For example, elements 602, 604, 606, and 608 of FIG. 6 may respectively correspond to elements 502, 504, 506, and 508 of FIG. 5. However, in contrast to D(t) 510, D(t) 610 is also based on the additional leaky bucket expression LB(t) 612, where this additional leaky bucket is filled by P 614. In particular, the constrained traffic shaping regulator enforces an envelope of the form E(t)=min {Pt ; b+rt}, as shown in FIG. 6. In other words, the minimum value selected from the two buckets of FIG. 6 passes through to D(t) 610. A dual leaky bucket provides the ability to regulate the traffic rate on a short term (via parameters P 614 and b) and the long term (via parameter r 608), providing flexibility to handle complex arrival functions (e.g., complex formulations of A(t) 602). Traffic rate r 608 can be configured as an average rate of the traffic arrival process, such as the long-term average traffic rate. When the peak rate P 614 is greater than r 608, it represents the maximum data rate of the dual leaky bucket system. The peak rate parameter P 614 bounds the maximum short term transmission rate at which traffic departs the traffic regulator. Timing diagram 650 shows how traffic rate r 608 and peak rate P 614 evolve over time. When P 614 is less than r 608, as shown by the bold line segment 652, traffic is enforced at rate P 614; however, when P 614 is greater than 4 608, as shown by the bold line segment 654, traffic is enforced at rate r 608. In some embodiments, the dual leaky bucket for UL traffic shaping can be implemented in a cellular network.

In some embodiments, the selection of peak rate P 614 may be determined by either: (a) a function of the network resources, e.g., when network resources impose constraints on the maximum rate at which traffic can be processed or transmitted, such as a maximum data burst volume (MDBV) within a period; or (b) a function of the data traffic, e.g., for a transmission of compressed/coded video data traffic. To further define the video data traffic transmission example, a video encoder may require that a video frame must be fully transmitted before the arrival of next frame from the application; and the rate P 614 may be given by the ratio of the largest video frame (in bytes) multiplied by the frame rate (e.g., 50 frames per second). In another example, a gated transmissions can be defined where if a certain PDU (e.g., PDU “x”) within a PDU set succeeds, then a traffic shaper may proceed to transmit further PDUs of the set (e.g., the PDUs with indices greater than x); however, if transmission PDU x does not succeed, then a traffic shaper may halt (e.g., by putting in a buffer) additional PDU transmissions. In such a case of halting additional transmissions, rate P 614 should satisfy the transmission of PDU x in a subsequent grant.

With respect to current communication standards (e.g., as per 3G and 4G protocols), there may be an opportunity to improve TB construction efficiency and there may be a need for a new layer two (L2) data plane interface. A typical user plane interface was designed to meet best effort data traffic according to a minimum flow rate and guaranteed bit rate requirements, without having many additional capabilities. Compared to a typical L2 data plane, a new L2 data plane interface can realize any one or more of the following features.

A new L2 data plane may improve computational efficiency. L2 processing scales linearly with packet rate. Thus, as the packet rate increases, it can significantly boost processing demands and power consumption, creating overhead challenges for both the network and the WTRU. Layering of L2 protocols, as may occur in traditional architectures, creates an overly hierarchical structure that may create latencies and increase computational complexity.

A new L2 data plane may improve quality of service (QoS), latency, reliability, or any combination thereof. A new L2 interface may support a variable QoS requirement, low latency, and high reliability, including when working with extreme applications, such as extended reality (XR), virtual reality (VR), augmented reality (AR), high reliability low latency communication (HRLLC), or enhanced ultra reliable low latency communication (eURLLC). Retransmissions currently are duplicated in multiple layers. Retransmissions at higher layers (e.g. radio link control (RLC)) are too slow to meet latency sensitive applications (e.g., as are found in XR applications). Retransmissions may also be quite rigid (e.g., requiring that retransmission data is exactly the same, TB size across transmissions is consistent, a single carrier is used, or other inflexible requirements). QoS attributes can be assigned to each data set/channel, including the dual key performance indicators (KPIs): priority, PBR, packet delay budget (PDB), packet error rate (PER), block error rate (BLER), and additional KPIs: PDU set delay budget (PDSB), dependencies to other sets, strict delay, energy consumption, complexity metrics. A new L2 interface may provide elastic quality of experience (Quen) level varying (e.g., with QoE being between the minimum data rate, or GBR, and the maximum data rate), while satisfying QoS requirements. Moreover, the QoE may be configured to meet a certain minimum requirement. For example, the WTRU may start transmission of data with a given QoE level that is higher, then as WTRU moves out of coverage, experiences cell congestion, or when data rate drops, the WTRU may then reduce the QoE level or reduce the number of data packet sets that are transmitted (e.g., if there are multiple/multi-modal streams, the WTRU may drop one stream that is not necessary to meet the min QoE level while still maintaining the QoS).

A new L2 data plane may support different data types. In some typical L2 data planes, signaling radio bearer (SRB) data and data radio bearer (DRB) data are differentiated, and treatment of user plane (UP) data QoS is controlled by QoS flow to DRB mapping. After having been mapped to a DRB, data packet treatment is done semi-statically. However, new system applications (e.g. AI/ML, XR, sensing, volumetric video, any other new application, or any combination thereof) introduce new data types, which may potentially be provided within a QoS flow. NR UP does not provide differentiated treatment for more important/systematic packets (e.g. for a QoS flow). Even so, data sets can be classified by type (e.g. control, data, sensory, AI/ML data). The L2 interface may therefore be configured to avoid unnecessary data transmission and to handle QoS/QoE dependencies between different data types (UP, CP, system data), including dependencies between data packets of the same type.

A new L2 data plane may improve WTRU and/or network power consumption efficiency. The L2 protocol should enable both WTRU and network (NW) power savings. DRBs are not elastic in terms of resource allocation and mapping across cells and cell groups. The L2 interface may therefore support means for timely WTRU reachability and WTRU processing chain power consumption, thereby balancing NW & WTRU energy consumption. A PDU should be able to be transmitted and/or received in a dynamic manner, without rigid restrictions on DRB, carrier, cell group, any other network entity, or any combination thereof.

A new L2 plane may improve the network's ability for data scheduling, including handling various levels of data capacity and handling data congestion. Configured grants may be responsive to delay bounds but may consume heavy overhead. Transmission on dynamic grants following status report (SR)/buffer status report (BSR) can incur delays. LCP can be based on leaky bucket uplink traffic shaping, and may not consider inter-packet associations, latency bounds, or congestion.

A new L2 plane may provide application layer awareness. NR UP does not provide prioritized treatment for high-priority data packets (where the relevance of the priority may vary over time or over other control reception, e.g. within a bearer). However, various applications generate data packets of varying importance. L2 protocols have not evolved with new application layer transport protocols (e.g., QUIC can be developed for faster, more reliable, and more efficient data transfer). Asa used herein, awareness includes a RAN being aware of application QoS and QoE metrics/data (e.g., events, important/relevant data) and the application being aware of RAN dynamic conditions (e.g. radio conditions, congestion, cell load, any other RAN condition, kor any combination thereof). An application itself may adjust the rate of the packet set, and in such case the WTRU should not exhibit a different underlying QoE level (e.g. when the video rate is decreased by the application). This capability may be provided whether or not the WTRU is aware of the application layer (e.g., there may be a first case for a WTRU with no awareness, and a second case for a WTRU with some type of awareness). Awareness may also involve awareness of application flow dependencies and synchronization and other system data (e.g. sensory, ML, CP triggered events such as network handover, any other suitable data, or any combination thereof).

In some embodiments of this disclosure, systems, methods, apparatuses, or any combination thereof, are provided to relax stringent minimum preparation time as is required for late construction of a TB (e.g., immediately before sending the corresponding data). Moreover, advanced preparation of other aspects of the transmission, such as those including delay critical data, and reduced hardware (HW) complexity associated with late construction of the TB may be provided herein. More generally, these provisions may reduce energy and HW/software (SW) complexity associated with executing a UL resource allocation algorithm.

Managing computational complexity and energy associated with an LCP may require reconsideration of typical LCP algorithms. From a perspective of low complexity WTRUs, a typical LCP algorithm may have a complexity that scales with N (which may be a large number), where N is the number of flows competing for resources in the UL grant. Further, there may be multiple communication steps that involve these N flows. For reduced capability devices, such as smart phones in energy efficient states or IoT devices, a considerable reduction of the LCP algorithm would help to reduce the HW cost and also the computational complexity and energy associated with processing grants, especially a larger quantity and/or increased volume of grants.

From the perspective of devices supporting high QoS communications, the scheduling delay (e.g., the time needed to send SR/BSR, receive a grant, multiplex data on the grant, or any combination thereof) can be reduced if the WTRU can start processing the transport block (e.g., at least the parts containing delay critical data) ahead of the grant reception.

In some embodiments of this disclosure, preprocessed (e.g., prior to reception of a grant) TB construction is provided. In one example, a WTRU (e.g., any WTRU 102) preprocesses an UL TB based on one or more TB construction assumptions prior to the reception of the actual grant. Then, at time of grant reception, the WTRU transmits the pre-processed TB if it matches the one or more TB construction assumptions. An illustrative and nonlimiting method for preprocessed TB construction is provided as follows.

At step 0 (e.g., corresponding to time T0), the WTRU transmits a grant-preprocessing assumption indicating data arrival and a TB construction assumption(s) for the associated data arrival. These assumptions may be made/transmitted as part of (or along with), BSR or SR transmissions (e.g., upon arrival of data). These assumptions may be made from only from a subset of data flows (e.g., that are either configured or have delay critical data buffered at the WTRU). These assumptions can be conditioned to be transmitted only when an SR or BSR is triggered for transmission or upon data arrival from the associated data flows. As the name indicates, a TB construction assumption may be an assumption that is made (e.g., at a WTRU) about a detail related to constructing a TB. For example, a grant/TB construction assumption may include a transport block size (TBS), a UL traffic shaping assumption/policy, a subset of involved data flows (e.g. a subset of logical channels (LCHs)), a minTBS bits that can be pre-processed, TB construction/LCP assumption, a coding rate, any other suitable information, or any combination thereof.

At step 1 (e.g., corresponding to time T1,where T1 is after T0), the WTRU pre-processes the TB based on a given grant and further based on one or more TB construction assumption that, e.g., includes a TBS and/or a QoS treatment policy. The WTRU may process part of the TB (e.g., up to minTBS bits) or the whole TB. The TB processing may be limited to a subset of data types, a subset of LCHs that are configured (e.g., delay critical data, periodic data, or data that isn't related to aperiodic arrival), or for RLC PDUs that aren't subject to segmentation. The WTRU determines whether data is delay crucial (e.g., based on remaining time being less than a threshold, where the remaining time may describe a time until the PDB is exhausted, or a time until a related discard timer expires). The WTRU may determine that a PDU is subject to segmentation as a function of the data type, data flow, QoS class, or whether the SDU satisfies a pre-allocation of minTBS bits. Step 1 can be performed on a subset of time slots at semi-statically configured occasions or upon receiving a first indication from the NW (e.g., a grant in response to SR). For example, semi-statically configured occasions may refer to occasions that are configured at pre-determined intervals and that stay the same in between those pre-determined intervals.

In connection with step 1, the WTRU may reserve space in the grant for inclusion of some MAC control elements (CEs) and MAC headers, where the MAC CEs themselves are provided in a later period, e.g., between T1 and grant reception time (T2) or transmission time (T3). One or more MAC CEs may be processed at T1, between T1 and T2, between T2 and T3, or at any other suitable timing. This timing can be predefined in communication specifications. Alternatively, the WTRU may configure (e.g., preprocess) the TB(s) up to a threshold level of bits. One or more preprocessed TBs may be prioritized over any MAC CE(s) that are triggered on or after the preprocessing takes place.

After step 1, a WTRU may receive a UL grant for transmission of new data (e.g., corresponding to time T2, where T2 can be before or after T1).

At step 2 (e.g., corresponding to time T3, where T3 is after T2) the WTRU transmits the TB if a TB construction assumption signaled in the data center interconnect (DCI) matches one of the pre-processed TB assumptions (e.g., if TBS(grant/DCI) is greater than or equal to TBS, where TBS may be a function of the TB). A reduced minimum preparation time is predefined or configured from the signaling of the second indication to the transmission start time. On the other hand, if the assumption is not met (e.g., if TBS(DCI) less than TBS, where TBS may be a function of the TB or if a MAC CE that has been preprocessed has changed), then the WTRU may take one or more of the following actions. The WTRU may use the grant with a reduced complexity LCP algorithm (e.g., as further described below). The WTRU may flush the hybrid automatic repeat request (HARQ) process buffer and reconstruct the TB. The WTRU may transmit a part of the preconstructed TB (e.g., a subset of the code blocks (e.g., a CBG based transmission). The WTRU may (e.g., to receive another grant) provide to the NW an indication that it doesn't have a matching TB assumption, a request for a subsequent grant, a multiplexed BSR (e.g., truncated, regular or a padding BSR), an indication that it has another MAC CE to transmit, or any combination thereof.

In some embodiments of this disclosure, reduced-complexity (e.g., compared to that of a typical approach) TB construction is provided. In one example, a WTRU (e.g., any WTRU 102) proportionally divides UL resources within a grant between buffered data flows, where the proportion is a function of PBR, water level in the shaping bucket (Bj), and/or priority. Aspects of reduced-complexity TB construction are provided as follows.

In some embodiments, the reduced-complexity TB construction is provided based on a single step bit allocation. This single step bit allocation may include simultaneous and parallel bit allocation for all flows, rather sequential allocation per flow. This single step bit allocation may include the WTRU dividing UL resource allocation within a grant, where the allocation may be proportional to PBRs, Bj levels (e.g., the amount of data bits in the shaping bucket), buffered data levels, data flow priorities, or any combination thereof. The WTRU may allocate unused portions of the grant as padding bits (e.g., including when there is buffered data from other LCHs). The WTRU may complete a grant by filling the allotment with a padding or by providing a truncated BSR, if possible.

In some embodiments, the reduced-complexity TB construction is provided based on a prioritized allocation (e.g., a first allocation, or a static priority allocation). This prioritized allocation may include a static priority in which priority is determined by the Bj(LCH) level (e.g., the product of the PBR multiplied by the time since the LCH was last served). The WTRU can select the LCH of the highest Bj level first. This prioritized allocation may include a static priority in which priority is determined by a number of buffered bits, by other suitable criteria, or by any combination thereof. This prioritized allocation may include a BSR (e.g., a padding BSR), which may be included for LCHs for which a Bj level was not allocated. This prioritized allocation may be determined based on the amount of LCH delay critical data, or whether the LCH has delay critical data with remaining time less than a threshold. This prioritized allocation may be determined based on LCH LCP priority. This prioritized allocation may be determined based on the data type or the QoS class associated with the data. This prioritized allocation may be determined based on the MAC CE type, where some MAC CEs have higher priority data, and other types have lower priority data.

One illustrative method (e.g., to be performed by any WTRU 102) for configuring a low complexity LCP is provided as follows. The WTRU is configured with a data allocation size (DAS) (e.g., in bits) for a given LCH. At step 1, the WTRU select the LCH with the largest Bj for data multiplexing, and the WTRU allocates DAS bits to the selected LCH, and decrements the value of Bj(LCH). At step 2, after each allocation of DAS bits, the WTRU checks whether Bj for selected LCH is less than another LCH “B”. If Bj is less than the LCH B, then the WTRU returns to repeat the operations of step 1; otherwise, the WTRU returns to repeat the operations of step 2.

As used herein, a gated (e.g., periodic) data set may be defined as a as a data set in which there are subsets of gating PDUs and non-gated PDUs. Communications may be configured such that transmission of a gating PDU enables the transmission of non-gating PDUs. For example, if PDU “x” arrives every “y” ms, and PDU x is a systematic gating PDU that enables a gated transmission, then PDU x+1 may not be transmitted if PDU x is not transmitted, or if PDU x is not deemed to be transmitted successfully (e.g., it is not acknowledged). In another example, if PDU x arrives at or is transmitted at time instance t, then all PDUs between t and t+y are not transmitted unless PDU x is recognized (e.g., acknowledged) as being transmitted or transmitted successfully.

One illustrative use case of embodiments of this disclosure is for video traffic with systematic frames. Some video applications do not benefit from transmission of frames following a systematic frame, e.g., because the video's picture is incomplete until the systematic frame arrives. In other words, the systematic frame should be fully transmitted before the transmission of subsequent frames. For such systematic frames, the WTRU may increase the transmission rate (r) or reinitialize the bucket with a bucket size (b) value to meet scheduling of such a systematic PDU (e.g., the WTRU may select a set of parameters associated with such higher QoE transmission). For other (e.g., non-systematic) PDUs, the WTRU may use lower values for b and/or r.

As used herein, data flows, DRBs, LCHs, logical queues at the WTRU buffer and/or QoS flows can be used interchangeably.

As used herein, channel conditions may include any conditions relating to the state of the radio/channel, which may be determined by the WTRU based on a WTRU measurement (e.g., layer 1 (L1)/signal-to-interference-plus-noise ratio (SINR)/reference signal received power (RSRP), channel quality indicator (CQI)/modulation and coding scheme (MCS), channel occupancy, received signal strength indicator (RSSI), power headroom, exposure headroom), L3/mobility-based measurements (e.g., RSRP, reference signal received quality (RSRQ), s-measure), a radio link monitoring (RLM) state, a channel availability in unlicensed spectrum (e.g., whether the channel is occupied based on determination of a listen before talk (LBT) procedure or whether the channel is deemed to have experienced a consistent LBT failure), any other suitable information, or any combination thereof.

As used herein, uplink control information (UCI) may include CSI, HARQ feedback for one or more HARQ processes, scheduling request (SR), link recovery request (LRR), configured grant (CG)-UCI and/or other control information bits that may be transmitted on the physical uplink control channel (PUCCH) or the physical uplink shared channel (PUSCH).

As used herein, a property of scheduling information (e.g., an uplink grant or a downlink assignment) may include at least one of a frequency allocation, an aspect of time allocation, such as time instance or/and a time duration, a priority, a modulation and coding scheme, a transport block size, a number of spatial layers, a number of transport blocks to be carried, a TCI state or SRI, a number of repetitions, whether the grant is a configured grant type 1 (e.g., the WTRU immediately using the configured UL resources after receiving the configuration information), type 2 (e.g., the WTRU waiting until an explicit MAC CE indication before using the configured UL resources) or a dynamic grant, or any combination thereof.

As used herein, an indication by DCI, or an indication, may include at least one of an explicit indication by a DCI field or by radio network temporary identifier (RNTI) used to mask cyclic redundancy check (CRC) of the PDCCH; an implicit indication by a property such as DCI format, DCI size, coreset or search space, aggregation level, identity of first control channel resource (e.g., index of first CCE) for a DCI, where the mapping between the property and the value may be signaled by radio resource control (RRC) or MAC; an explicit indication by a DL MAC CE; or any combination thereof.

As used herein, a traffic shaper is a scheduling implementation which enforces that departing UL traffic complies to a given traffic envelope and which may also buffer non-compliant traffic.

One example of a traffic shaper is the leaky bucket. Another example is the dual leaky bucket. Either leaky bucket implementation may include shaping exceptions when some conditions are met. Either leaky bucket implementation may include multiple traffic shapers, with one or more traffic shaper applicable for a given time/grant. When more than one traffic shaper is applied, the minimum shaping level (e.g., minimum water level) of the multiple shapers may be taken as the overall traffic limit.

One example of a traffic shaper is the maximum burst size shaper (e.g., in which E may describe the burst size).

One example of a traffic shaper is the deterministic shapers for periodic traffic (e.g., in which E may be set equal to A(period)/period).

One example of a traffic shaper is a time variant shaper (e.g., which may be enabled by a NW signal to control shaping parameters). The time variant shaper could be a leaky bucket with dynamically signaled shaping parameters (e.g., r, b, P, BSD).

One example of a traffic shaper is one that takes the shortest remaining time first, among buffered data units applicable for the grant.

One example of a traffic shaper applies the highest static priority first (e.g., highest QoS class) when considering multiple buffered data units that are applicable for the grant.

One example of a traffic shaper is the first in first out approach when considering buffered data units applicable for the grant.

One example of a traffic shaper is the no shaping approach, in which a data flow is not limited or is limited only to the size of the grant.

A WTRU (e.g., any WTRU 102) may maintain a UL traffic shaping bucket (e.g., defining a Bj term) for each data flow, for each QoS class, for each UL traffic shaping envelope, or for any combination thereof. When serving buffered data from a given flow and when allocating UL resources in the grant to the data flow (e.g., when coordinating bit allocation in the TB), the WTRU may decrease the bucket by the value of the served buffered bits. The water level in the bucket (e.g., the Bj term) may be negative, such as when exceptions occur (e.g., when using a non-default envelope or when serving data from data units of a certain QoS class). For a given grant, at least in a first allocation step/round, the WTRU may serve buffered data to the grant from each flow up to the water shaping level (e.g., Bj). In a later round(s), the WTRU may allocate remaining resources in the grant according the same envelope, according to a different envelope, or without any shaping. The water level (Bj) may be decreased in the first and/or the later round(s), e.g., based on resource allocation.

For a given data flow for which the WTRU maintains a shaping envelope (e.g., based on a bucket), should the WTRU change the shaping envelope for a subset of data units, the WTRU may update the envelope (e.g., update the bucket) as follows. The bucket may be updated based on the water level (Bj)=Bj+the fill rate (r) of the applicable envelope, multiplied by time since the bucket was last updated. The bucket may be updated by filling the bucket with the value “b” of the applicable envelope. The bucket may be updated by assuming an updated bucket size (e.g., to BSD multiplied by r), e.g., with the applicable envelope being used for a given data unit.

In some embodiments, the NW includes knowledge of the shaping parameters/envelope, and if the WTRU autonomously changes any shaping parameters, the WTRU may further notify the NW (e.g., via notifying the serving cell, such as by using part of the assistance info or a MAC CE).

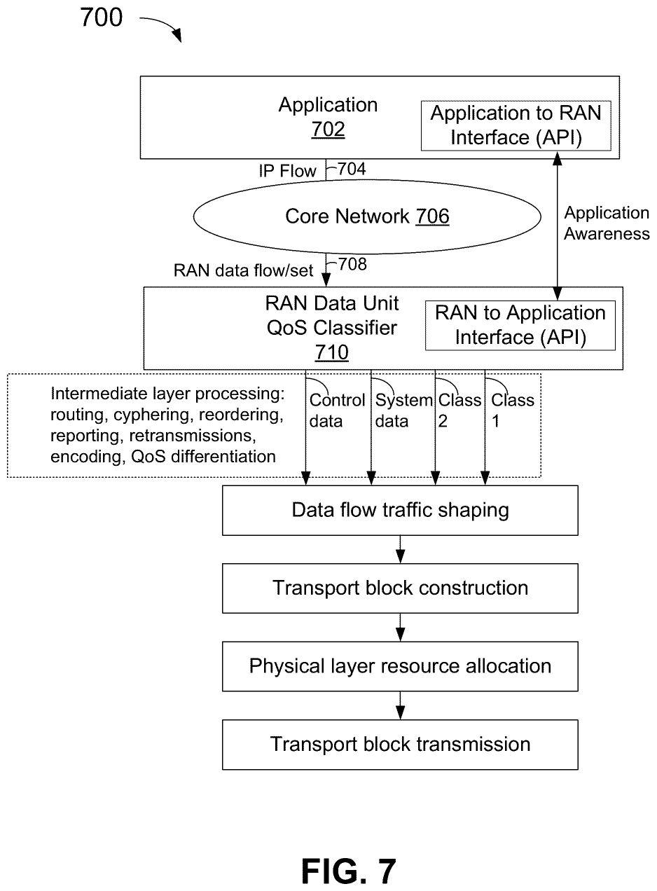

In accordance with some embodiments of this disclosure, an illustrative RAN data plane architecture 700 is shown in FIG. 7. As shown, an application 702 provides one or more IP flows 704 for transmission over a medium. Each IP flow then goes through a transport layer protocol (e.g., TCP/IP, QUIC, RTP, MOC, or any other suitable transport layer protocol). Each IP flow (e.g., a PDU session) goes through a RAN core network 706 (e.g., which may correspond to RAN 104 and/or core network 106), which maps it to a RAN data flow 708 (e.g., which may be a RAN data set). For each RAN data flow, the core network may attach QoS requirements, a QoS metric, a range of QoE metrics, any other suitable figures of merit, or any combination thereof.

As used herein, a RAN data flow 708 may represent a logical association between data units (such as data packets), e.g., where the packets originate from the same IP flow. Such association may be based on data units being associated to the same IP flow, to the same application flow, or having the same association packet as marked either by the core network 706 or the application 702.

Some RAN data flows 708 may not originate from a user application 702, but rather from a control plane (e.g., control data and RAN signaling and configurations), an intelligence plane (e.g., data collected from AI/ML services), a computing plan (e.g., used for native computing for computing services), a system plane (i.e. data originating within the RAN, e.g., due to sensing or positioning services), a security plane, or any combination thereof.

The WTRU may assign a QoS class to each data unit within a RAN data flow 708 for the purpose of characterizing how related data should be transmitted. A data protocol plane may contain a data unit classification function for QoS/QoE marking throughout the protocol chain. The QoS/QoE class can be determined in the appropriate data plane layer (e.g., at the RAN data unit QoS classifier 710) according to one or more configured or predefined rule. As shown, the RAN data Unit QoS classifier 710 may communicate with the application 702 via respective APIs, and this API-to-API communication may provide the application with awareness of details of the RAN, or vice versa. The classified QoS class can be used (e.g., during intermediate layer processing, including any of the related tasks as shown in FIG. 7) in various layers within the data plan protocol chain for achieving a certain QoS requirement or a QoE level. A QoS class (e.g., such as class 1 or class 2, as shown in FIG. 7) can indicated as part of a protocol layer header. Control data and/or system data can also be indicated as part of a protocol layer header or other suitable information. Each QoS class may be associated with a QoS treatment profile in the RAN, which may be configured semi-statically. Each QoS treatment profile may contain a number of parameters to control the RAN treatment of the data transmission/reception and a number of metrics to achieve the QoE level for a given layer in the protocol chain. Each QoS class or QoS treatment profile may be configured (e.g., associated) with a priority index, an importance level, a delay bound, a reliability level, a guaranteed bit rate, a maximum bit rate, a maximum packet loss rate, other suitable service information, or any combination thereof.

Based on the output of RAN data unit QoS classifier 710, as well as corresponding intermediate layer processing, the architecture 700 may be configured for data flow traffic shaping, transport block construction, physical layer resource allocation, and transport block transmission, as shown in FIG. 7.

In some embodiments, conditions and rules for classifying packets within a data flow are provided as follows.

The WTRU (e.g., any WTRU 102) may use a procedure to classify UL data units (e.g., packets within a data flow, SDUs, PDUs within a PDU set) on a dynamic basis. For example, a data unit can be assigned with a corresponding QoS Class based on one or more conditions of the data unit.

When a condition for QoS classification is met, the WTRU may assign a certain QoS class value to a given data unit. That QoS class may or may not be the default QoS class. For example, the WTRU may be configured with a default QoS class, which may be preconfigured semi-statically for an entire data flow. If no special classification conditions are met, then the WTRU can classify a data unit from such a flow with the preconfigured default QoS class for the data flow. Moreover, the WTRU may be preconfigured with one or more non-default QoS class(es). There may be a mapping between a given non-default QoS class and a condition that causes a data unit to be applied to one of the non-default QoS classification. If such a condition is met, then the WTRU may associate the data unit with the non-default QoS class.

Illustrative and nonlimiting conditions for QoS classification are provided as follows. Each of these conditions may be used alone, or in any suitable combination.

One condition for QoS classification is based on packet priority. Based on the possibility of transmission/inclusion of buffered data from a subset of PDUs within a PDU set, such PDUs can be configured (e.g., predetermined) to be of higher priority, to have a lower delay bound, to have a high QoS treatment profile compared to other PDUs within the set, or any combination thereof. If the data unit is of higher priority, then the WTRU may associate the data unit with a given QoS class. If the data unit is of lower priority, then the WTRU may associate the data unit with another QoS class.

One condition for QoS classification is based on packet importance. Based on the possibility of transmission/inclusion of buffered data from a subset of PDUs within a PDU set, such PDUs can be configured (e.g., predetermined) to be of higher importance compared to other PDUs within the set, where importance is a value obtained from an indication from the core network packet profile, the application interface, or from service characteristics (e.g., based on the period of the packet or the type of packet associated with it). If the data unit is of higher importance, then the WTRU may associate the data unit with a given QoS class. If the data unit is of lower importance, then the WTRU may associate the data unit with another QoS class.

One condition for QoS classification is based on packet delay budget. Based on the possibility of transmission/inclusion of buffered data from a subset of PDUs within a PDU set, the remaining time until the delay budget for the PDU or the underlying application may be less than a threshold. If the delay budget is less than a threshold, then the WTRU may associate the data unit with a given QoS class.

One condition for QoS classification is based on data type. A condition can be met as a function of inclusion of data from a given data type, e.g., data from AI/ML, XR, sensing, volumetric video, or any combination thereof. For example, for a first data unit containing AL/ML data, the WTRU may associate data unit with a first QoS class; for a second data unit containing sensing data, the WTRU may associate data unit with a second QoS class.

One condition for QoS classification is based on reception of an indication (e.g., from an application or from an RAN-application interface, such as an API). The application may indicate that a differentiated QoS class is to be associated with a given data unit. The indication may provide a given QoS class or an identifier associated with the given QoS class. The WTRU may be configured with a given non-default QoS class that is applied to a data unit when an indication/flag is received from the API for the data unit. For example, upon reception of an indication from higher data plane layers (e.g., from an application) indicating that a given data unit needs to be prioritized ahead of other buffered unit in the queue for a corresponding data flow, the WTRU may associate a different (e.g., non default) QoS class to the data unit.

One condition for QoS classification is based on reception of an indication from a network (e.g., where the network may override a configured default QoS class for one or more data flows). The indication may include a given QoS class to apply, and the indication may further include an amount of time for which it should be considered. Such an indication may, e.g., be determined as a function of a property of the scheduling information (e.g., in the DCI), by a direct indication by DCI, by any other suitable network function, or any combination thereof.

One condition for QoS classification is based on reception of an indication in a given grant. A DCI may signal a given QoS class, and only data associated with the signaled class may be multiplexed. Alternatively, the WTRU may typically multiplex data of a grant, and may then treat the whole TB as data with the signaled QoS class (e.g., including the data in lower data plane layers). Such an indication may be included within a function of a property of the scheduling information (e.g., in the DCI), may be included as an indication by DCI, may be included in any other suitable network function, or may be included in any combination thereof.

One condition for QoS classification is based on data from a gating data set. For example, the WTRU may associate a given non-default QoS class to a gating data unit.

One condition for QoS classification is based on a function of dependent data or on a data set. For example, there may be a data unit that other data units depend on (e.g., an FEC source packet, a video defining frame such as an I frame, a gating data unit, or any combination thereof) a non-default (e.g., prioritized) QoS class may be assigned. In contrast, for dependent, duplicated, or redundant data units, a different QoS class may be assigned (e.g., where the different QoS class may be a default QoS class associated with the flow).

One condition for QoS classification is based on a function of systematic PDU within a data set. The systematic PDU may be based on the transmission/inclusion of buffered data of a systematic frame/data unit within a data flow (e.g., source data units that are encoded, systematic video frames, any other suitable data flow, or any combination thereof).

One condition for QoS classification is based on satisfying one or more control plane event, e.g., satisfying one or more mobility event condition, satisfying a conditional handover condition to one or more handover candidate, or any combination thereof. For example, upon satisfying a mobility event condition, an RLM, a beam failure, an RLF, or any combination thereof, the WTRU may associate a different QoS class with a data unit. This association may last for a period of time that is determined based on the CP event.

One condition for QoS classification is based on sensing an object or determining an outcome from a sensing or positioning procedure. For example, sending data may be configured (e.g., pre-associated) with a given QoS class. Upon detection of an object as a function of sensing or a spatial computing service as a outcome of sensing, the WTRU may select a certain QoS class (e.g., a non-default QoS class, or a configured QoS class).

One condition for QoS classification is based on dropping or adding one or more data flows. Upon adding or dropping one or more service or a data flow (e.g., from a multi-modal service or session), the WTRU may change the QoS class associated with the remaining data flow or dependent data flow.

One condition for QoS classification is based on synchronization between data flows. If synchronization between data flows is configured or indicated from the application or the core network, the WTRU may associate a first QoS class for data units associated with a synchronized data flow (e.g., a dependent data flow), and a second QoS class for data units associated with an unsynchronized or incorrectly synchronized data flow (e.g., where incorrect synchronization could be determined based on a remaining synchronization time being greater or less than a threshold). If a common identifier is used (e.g., signaled from the application or the core network) to associated two flows, then the WTRU may use a single QoS class for data units of both data flows. If associated data flows are dissociated, then the WTRU may revert to the default QoS classes individually configure each data flow.

One condition for QoS classification is based on dropping or adding one or more dependent data types. If the WTRU is configured to need “x” of “y” data units to decode an overall data unit (e.g., an FEC encoded packet, a source video frame, any suitable data packet, or any combination thereof), then the WTRU may select a given QoS class when the x out of y units have been successfully decoded, whereas the WTRU may associate a different QoS class when the x out of y have not been successfully decoded, when x′ out of y units have been received, when x″ units have been received but not acknowledged, or when any combination of those events occurs.

One condition for QoS classification is based on satisfying one or more event from the transport layer protocol (e.g., where the event may be generating TCP ACK, transmitting an out of order data unit within a transport protocol session/connection, reading a specific value from the header of the transport layer protocol for a given data unit, or any combination thereof). When such an event occurs (e.g., causing a condition to be met), the WTRU may associate the associated data unit of the related RAN data flow with a given QoS class. The WTRU may be able to determine one or more property of the transport layer protocol from a relay on top of the RAN protocol stack, and this property may be used to de-cypher and/or decrypt the transport layer header and any other encrypted content.

One condition for QoS classification is based on measuring a channel condition to be below or above a given threshold, or based on measuring a change in the channel conditions to be below or above a given threshold. In response, the WTRU may associate a data unit with a given QoS class.

One condition for QoS classification is based on a function of whether the data unit is initially transmitted or if it is retransmitted (e.g., with this condition optionally being further based on the retransmission number).

One condition for QoS classification is based on an energy-saving state of the NW (e.g., which may be indicated to the WTRU) or an energy-saving state of the WTRU (e.g., which may be determined based on whether DRX is being used).

In some embodiments, any of the above conditions, or any other suitable transmission-related condition, may be imposed for a period of time, and after being satisfied, it may be considered satisfied until the period of time (which may be actively configured or predetermined) has elapsed. While the condition is met and during the period of time, a differentiated QoS class may be applied to data units. When the period expires, the data units may be associated with a default QoS class or a reverted QoS class (e.g., that was assigned before the condition was met). A condition may be imposed for a subset of data flows (e.g., a QoS flow, data unit set, a DRB, LCH, logical channel group (LCG), PDU set, or any combination thereof). When the condition is satisfied, the WTRU may determine that the condition is applied only for the applicable set of data flows (e.g., and the condition may be configured by higher layer signalling), and the WTRU may apply the associated QoS class for the data unit. A condition may be constrained to a subset of data types (e.g., control data, user data, system data, intelligence data (AI/ML), positioning data, sensing data, or any combination thereof). When a condition is satisfied, the WTRU may determine that to apply the condition only for the applicable type of data (e.g., and the condition may be configured by higher layer signalling), and the associated QoS class may be applied for the data unit. A condition may be constrained to a subset of device capabilities. A condition may be constrained to a subset of uplink grants, to a subset of grant types (e.g., dynamic vs. semi-static/configured grants), to a subset of grant indication properties, to property of the grant scheduling indication (e.g., as per the DCI indication, or as a function of the DCI scheduling parameters), or to any combination thereof.

The purpose of pre-processing a TB is to construct a TB prior to grant reception. This pre-processing can reduce preparation time required to connect to the grant, e.g., to reduce energy and complexity requirements on the WTRU. In some cases, such pre-processing may be regarded as trading off some spectral efficiency to reduce the scheduling latency, to reduce complexity, to allow critical data to be transmitted as soon as possible, or any combination thereof.

In one method, the WTRU (e.g., any WTRU 102) may construct a TB (or at least one part of a TB) in a multi-stage process, whereby the WTRU MAC may pre-process and/or pre-construct a part or all of the TB, and the WTRU may further include (e.g., with the TB, or upon acknowledging a grant) an indication of such preprocessing. In some embodiments, illustrative and non-limiting conditions for pre-processing are provided as follows. Each of these conditions may be used alone or in any suitable combination.

One condition for pre-processing a TB is that the WTRU is configured (e.g., as a predefined setting) for, and/or capable of, constructing a pre-processed TB.

One condition for pre-processing a TB is that the data arrives from a subset of data flow(s), where at least one of the data flows are configured for pre-processing.

One condition for pre-processing a TB is that data arrives that is assigned to a QoS class from a configured subset of QoS classes, where the subset of QoS classes are configured for TB pre-processing/construction.

One condition for pre-processing a TB is that data arrives with an SDU of the same size (e.g., based on a packet size) and/or characteristics (e.g., same QoS profile) as a previously transmitted and/or acknowledged TB (e.g., where the TB and the arriving data could be within the same data flow).

One condition for pre-processing a TB is that data arrives from a given PDU set (e.g., a set of associated PDUs, which may be associated within a data flow or which may be from different data flows), where at least one PDU of the PDU set has been transmitted and/or successfully acknowledged/received.

One condition for pre-processing a TB is that the WTRU has received an indication from the network to allow TB pre-processing for a given data flow, LCH, LCG, SDU, PDU set, or any combination thereof. The indication can be an indication communicated in DCI or in a MAC CE. The indication can also be derived from a property of a communication scheduling (e.g., as may occur at the network, at the WTRU, or at both). The indication can be specific to a UL grant, a WTRU, a period of time, a data flow, an LCH/LCG, a specific data type, or any combination thereof. The indication to apply pre-processing (or not to apply pre-processing) may be applied for a period of time that is configured, e.g., after receiving the indication from the network.

One condition for pre-processing a TB is that the WTRU has received an indication from the network (e.g., as communicated in a MAC CE or DCI) that another UL grant will be available, is available, or is set to be scheduled, e.g., where the UL grant has a size that is below or above a threshold.

One condition for pre-processing a TB is that another UL uplink grant is available to the WTRU upon processing an initial, current, or prior UL grant. The other UL grant may be configured to satisfy a condition that makes it regarded (e.g., by the WTRU) as another UL grant. The pre-processing condition may be satisfied based on the UL grant satisfying the condition causing it to be regarded as another UL grant. For example, the UL grant may be configured to be available within a time limit (e.g., starting after a current UL grant is evaluated), to have a size/TBS greater than threshold, to permit multiplexing of the data of the SDU (e.g., as may be permitted by LCH restrictions, or removal of LCH restrictions), to satisfy the scheduling properties of a current UL grant (e.g., that may be under evaluation), to meet the physical layer transmission characteristics (e.g. MCS, reliability level, priority, MIMO layers, any other characteristic, or any combination thereof) of a current UL grant under evaluation, or any combination thereof.

One condition for pre-processing a TB is that a configuration is received (e.g., at the WTRU), where the configuration indicates whether or not to pre-process the TB. For example, the configuration may provide this indication based on data type, data flow, WTRU capability, PDU set being received, or any combination thereof.

One condition for pre-processing a TB is that at least one measured channel condition is below or above a threshold.

One condition for pre-processing a TB is that a TB processing size (e.g., a minTBS value) is below or above a threshold.

One condition for pre-processing a TB is the WTRU power headroom or the uplink transmit power is below or above a threshold. For example, the WTRU may preprocess a TB if the WTRU exhibits power headroom that is larger than a threshold, or if the WTRU exhibits a transmit power that is below a threshold (e.g., which may indicate that the WTRU is in a zone with a sufficiently high-quality UL signal). For another example, if an uplink grant is available and it is small (e.g., TBS is less than a threshold), or if the TB preprocessing size (e.g., based on minTBS being below a threshold) and channel conditions are above respective thresholds, then the WTRU may pre-process a grant/TB.

One condition for pre-processing a TB is that arrival data is a retransmission (e.g., an automatic repeat request (ARQ) retransmission) of a previously transmitted SDU, or a retransmission of a portion of a previously transmitted SDU. For example, the WTRU may pre-process the TB in response to receiving a negative acknowledgement (NACK), such as a HARQ NACK or a NACK in an RLC status report, for a given SDU.

One condition for pre-processing a TB is that the remaining time for buffered data, (e.g., based on a subset of data flows), is less than a configured threshold. The remaining time may be determined as the time until the PDB of the flow is exhausted or the time until the discard timer associated with the data unit expires (e.g., where such timer may be maintained at higher layers, such as by PDCP or by the segmentation/multiplexing layer itself, such as the MAC layer).

One condition for pre-processing a TB is that a new BSR is triggered (e.g., if the BSR is triggered by data arrival from a subset of data flows.

One condition for pre-processing a TB is that new delay status report (DSR) is triggered, (e.g., if the DSR is triggered by data from a subset of data flows). The DSR may report the remaining time associated with one or more outstanding data flows.

One condition for pre-processing a TB is that a new scheduling request (SR) is triggered (e.g., if the BSR/DSR is triggered by data arrival from a subset of data flows).

One condition for pre-processing a TB is that the WTRU has some SDUs (e.g., RLC SDUs) that do not require segmentation at higher layers (e.g., where a higher layer may be one above a MAC layer). The WTRU may determine that a SDU is subject to segmentation as a function of the data type, data flow, whether the SDU fits within a pre-allocation of minTBS bits, whether the SDU size is greater than threshold amount of bits, a configuration of the WTRU, or any combination thereof.

One condition for pre-processing a TB is that there is triggering of one or more MAC CE for transmission (e.g., of a certain type or priority, such as PHR, BSR, BFR, DSR, any other suitable priority, or any combination thereof).

One condition for pre-processing a TB is that the number of already pre-processed TBs is below a first threshold and/or the amount of data in already pre-processed TBs is below a second threshold. The WTRU may receive the value of first and/or second threshold from MAC or RRC signaling. The first and/or second thresholds may be applicable for a specific identified data flow or over all data flows for which TB pre-processing is configured.

Upon any of these TB pre-processing conditions being satisfied, the WTRU may provide an indication (e.g., part of a MAC CE, an SR, BSR, and/or DSR, or RRC message) that indicates the WTRU's TB pre-processing/construction assumption. Upon satisfying any of these conditions, the WTRU may construct a TB (or parts of a TB) using one or more TB construction assumption. A grant/TB construction assumption may include a transport block size (TBS), a UL traffic shaping assumption or policy (e.g., which may be used to pre-process/construct the TB), a subset of involved data flows (e.g., LCHs) for which the WTRU constructs the TB, a minTBS bits that can be pre-processed or the WTRU will use for TB pre-construction, a TB construction/LCP assumption, a coding rate (e.g., a modulation and coding rate), a QoS treatment policy/profile, or any combination thereof.

The WTRU may be configured with one or more indices (e.g., each with a respective magnitude) that correspond to each TB construction assumption, e.g., by semi-static (e.g., RRC) or dynamic signaling (e.g., a DL MAC CE or DCI). For each TB construction index, a corresponding semi-static configuration may include details to configure the parameters associated with the TB construction assumption. The WTRU may also provide the index or indices of the selected TB construction assumptions as part of an indication to the network (e.g., in a MAC CE or in a DSR or BSR). The time at which the WTRU satisfies the conditions for TB pre-processing and/or includes such indication for pre-processing can be referred to as time “T0”, which may correspond to T0 as indicated above in connection with transmitting a grant-preprocessing assumption.

At time instance “T1”, which follows T0 and may correspond to T1 as indicated above in connection with pre-processing the TB, the WTRU may pre-process and construct the TB (or parts of it) based on one or more TB construction assumption (e.g., where the assumption includes a TBS and/or a QoS treatment policy). The WTRU may determine the timing of T1 as a time between T0 and a T0 plus an offset, where the offset may be actively configured or it may be predefined. The WTRU may determine the timing of T1 (e.g., when the WTRU starts to pre-process a TB) as a time when (or after) the WTRU receives an indication from the network or a reply to the pre-processing indication (e.g., the SR/BSR/DSR). The WTRU may determine the timing of T1 to be part of a subset of slots or symbols that are preconfigured, e.g., with T1 falling only within periodic occasions that semi-statically configured. The WTRU may determine the timing of T1 as a time offset after including/transmitting an indication for TB pre-processing/construction, where the offset may be actively configured or may be predefined.

At a time instance “T2”, which follows T0 but may be before or after T1, and which may correspond to T2 as indicated above in connection with receiving a grant for transmission of new data, the WTRU may receive a reply to the indication of TB pre-processing/construction and/or an uplink grant. Upon receiving a grant, the WTRU may determine the transmission time of the grant (e.g., the PUSCH transmission) as time instance “T3” (which follows T2, and may correspond to T3 as indicated above in connection with transmitting the TB). T3 may be the determined from a property of the received scheduling information (e.g., by DCI) and/or from the time/frequency domain scheduling information association with the grant. Between times T2 and T3, the WTRU MAC may re-construct a pre-constructed TB according to one or more of the grant properties (e.g., TBS, MCS, code rate, traffic shaping policy, and/or a signaled QoS treatment profile) received in the grant. For example, if the signaled grant size is larger than TBS of the preconstructed TB, then the WTRU may allocate additional data bits and/or MAC CEs, or the WTRU may re-run LCP or a low complexity LCP algorithm (e.g., per the explanation for solution B in section 3) to complete TB construction according to the UL grant size.

In one example, the WTRU (e.g., any WTRU 102) may change the MCS to match the TBS of the pre-constructed TB. The WTRU may transmit a part of the constructed TB to match the TBS of the signaled grant. Between T2 and T3, the WTRU MAC may provide MAC CEs which have not been processed yet (e.g., BSR, DSR, or other suitable reports). In one example, the grant may signal a number of TB transmission assumptions (e.g., TBS, MCS, code rate, traffic shaping policy, a signaled QoS treatment profile, or any combination thereof), and the WTRU may select the grant transmission assumption that matches the selected TB pre-processing/construction assumption that was used to construct the pre processed TB. The WTRU may discard other grants, or aspects of other grant transmission assumptions that were not selected, e.g., if the other grants are overlapping with the selected grant (e.g., in the time and/or frequency domain).

In one method, the WTRU (e.g., any WTRU 102) may prepare the TB using more than one TB assumption (e.g., for different TBS). When the grant is received, the signaled assumption may be used and other TB assumptions may be flushed (e.g., put back into the queue at higher data plane layers).

Referring back to time instance T3, the WTRU may transmit uplink data in the scheduled grant. The WTRU may transmit a TB if at least one TB construction assumption(s) is met (e.g., if the WTRU has constructed a TB or pre-processed a TB using at least one TB construction assumption that matches the signaled DCI/UL grant). The WTRU may transmit a TB if a TB construction assumption that is signaled in the DCI matches one of the pre-processed TB assumptions. For example, the WTRU may transmit the TB if the TBS of the signaled grant/DCI is greater than or equal to the TBS of the preconstructed TB. A reduced minimum preparation time is realized between the signaling of the second indication (T2) and the transmission start time (T3).

If at least one TB construction assumption is not met, e.g., if TBS(DCI) is less than TBS(pre-processed TB), or if a MAC CE that has been preprocessed has changed, then the WTRU may use the grant with a reduced complexity LCP algorithm (e.g., as per the construction of the reduced-complexity TB, as mentioned above), and/or the WTRU may provide an indication to the NW that it doesn't have a matching TB assumption and/or that it has a multiplexed BSR. If the TBS of the grant is smaller than the TBS of the preprocessed TB, then the WTRU may flush the TB and construct another TB. A TB constructed after T2 may use a simplified LCP algorithm, or the grant can be used for one (or a limited number of) LCH (e.g., for one or more of the highest priority LCHs). In one example, if the TB construction assumption(s) is not met, e.g., because the TBS(grant/DCI) is less than the TBS(pre-processed TB), then the WTRU may transmit a subset of the TB parts (e.g., where the TB parts can be portions of a TB that are preconfigured (e.g., by the WTRU or the NW) or known by the network, and where each part may be separately decodable by the NW without needing to decode the whole TB), a subset of code blocks, or a subset of code block groups that fit within the grant (e.g., a CBG based transmission). In turn, the WTRU may include information about remaining TB parts, about CBs, or about CBGs that have been preprocessed but that have not been included in the grant for transmission (e.g., the remaining parts could be pending for transmission). For example, TB part 1 can be processed at time T1 (or otherwise after T0), TB part 2 can be processed between T1 and T2, TB part 3 can be processed between T2 and T3, and additional parts of the TB can be subsequently processed. The WTRU may trigger a transmission or a retransmission (e.g., an ARQ) to transmit bits that are left and were not included in the grant. In one method, if the TB construction assumption(s) do no meet the signaled grant, then the WTRU may flush a data buffer and trigger an ARQ retransmission to retransmit the TB at a later time/grant. In one method, if TB construction assumption(s) is not met, then the WTRU may keep the pre-processed TB buffered and use the grant for constructing another new TB, e.g., in anticipation of a later scheduling that can be used to transmit the that new TB. The WTRU may include an indication (e.g., in a MAC CE) about the buffered pre-processed TB that was not included in the grant transmission.

In one method, the WTRU (e.g., any WTRU 102) may process the TB up to minTBS bits, where minTBS is configured by the WTRU or signaled (e.g., by DCI or MAC CE) to the WTRU prior to the grant reception, or where minTBS is determined (e.g., by the WTRU, or at the NW) as a function of the time occasion (e.g., slot or frame) at which the WTRU preprocesses the TB. There can be a condition specifying that WTRU performs preprocessing of the TB for a certain minTBS bits of data that are known to the NW, e.g., to perform step 1 of LCP, of minTBS bits, and/or based on TBS of a previously received or current grant size. In one example, the WTRU may process TB for the first stage of resource allocation in LCP (e.g., up to Bj/PBR allocation for each flow), e.g., between T0 and T2 or between T1 and T2. The WTRU may process the second round of resource allocation in LCP after receiving the grant (e.g., after T2, between T2 and T3). If there are remaining unused bits in the grant, then the WTRU may multiplex more data prior to transmission.

In one method, the WTRU (e.g., any WTRU 102) may include a “next TB processing assumption” part of the transmission of a current grant (e.g., in a MAC CE or UCI multiplexed in the current grant, where the MAC CE or UCI indicates e.g., an index corresponding to the TB construction assumption to be used by the WTRU for the next TB the WTRU pre constructs). In one example, the WTRU may report the next TBS information and/or the WTRU may report a TB construction assumption for the next TB in the uplink scheduling (e.g., in BSR or SR). Such reporting may, e.g., be applied for delay critical data. In a scheduling request or BSR, the WTRU may indicate a TB processing assumption(s) needed for the grant. If delay critical data is buffered (e.g., if remaining time is less than a threshold), then the WTRU can report the existence of such data and compute the TB for that data. To receive another grant, the WTRU may provide an indication to the NW that the WTRU doesn't have a matching TB assumption, doesn't have a request for a subsequent grant, doesn't have a multiplexed BSR (e.g., truncated, regular or a padding BSR), doesn't have an indication that it has another (e.g., pending) MAC CE to transmit, or doesn't have any combination thereof.

The WTRU may process MAC CEs at the time of the first indication (T1), within a preparation time between the first and second indications (between T1/T0 and T2), or after grant reception (between T2 and T3). The selection of one of those time ranges may depend on the MAC CE type which is being predefined. For example, some MAC CEs (e.g., BSR or DSR) may be multiplexed shortly before transmission (e.g., between T2 and T3) and/or in connection with specific TB parts, while other MAC CEs that can be pre-processed (e.g., CRNTI or SPS confirmation MAC CEs) may be processed at T1 or between T1 and T2, e.g., before grant reception and/or generation of other TB parts. Some WTRUs may be restricted from providing MAC CEs shortly prior to TB construction, so preprocessing the TB at other times would reduce overall traffic shaping complexity. A WTRU may reserve a spare part in the grant for inclusion of MAC CEs, where the MAC CEs themselves may be included in a later period. This spare part can be separately decodable TB portions/MAC CEs within the TB, where the spare parts are encoded/decoded separately (e.g., may have separate CRCs and/or MAC headers). The WTRU may delay construction of some lower priority MAC CEs until after grant reception (e.g., after T2), and may then include these MAC CEs only if they fit in the grant (e.g., after all data and other control/MAC CEs of higher priority have been included). The priority of a MAC CE can be determined from a predefined prioritization list (e.g., which can include priority information for data and other control elements), or it can be actively configured.

The WTRU (e.g., any WTRU 102) may process MAC headers at the time of the first indication (T1), within a preparation time between the first and second indications (e.g., between T1/T0 and T2), or after grant reception (between T2 and T3). The selection of the time instance range may depend on the MAC header type which is being predefined. For example, some MAC headers may be multiplexed shortly before transmission (e.g., between T2 and T3) and/or in connection with specific TB parts, while other headers can be processed at T1 or between T1 and T2, e.g., before grant reception and/or generation of other TB parts. The WTRU may reserve a spare part in the grant for inclusion of MAC headers, where MAC headers are included in a later period. Such a spare part can be a separately decodable TB portions/MAC CEs within the TB.

The WTRU (e.g., any WTRU 102) may be configured to reserve or may be indicated to reserve an uplink grant for the transmission of pre-processed TB(s) of at least one data flow. The WTRU may receive the grant parameters by MAC or RRC (e.g., configured grant type 1), or it may be received dynamically from DCI (e.g., dynamic grant or configured grant type 2). The WTRU may determine whether a grant is reserved for the transmission of pre-processed TB(s) based on at least one of the following conditions.

One condition for determining whether a grant is reserved for the transmission of pre-processed TBs is an explicit indication from a field of the DCI indicating the grant, or from an information element of the configuration applicable to the grant. The explicit indication may also include the identity of at least one data flow, and for each data flow, at least one transport block size, a number of TBs and/or an amount of data. Illustrative and non-limiting conditions for determining whether a grant is reserved for the transmission of pre-processed TBs are provided as follows. Each of these conditions may be used alone, or in any suitable combination.

One condition for determining whether a grant is reserved for the transmission of pre-processed TBs is a delay (e.g., a K2 delay) between the DCI and the PUSCH as indicated from a field of the DCI. For example, the WTRU may determine that a grant is reserved for the transmission of pre-processed TB(s) if the delay is less than a pre-defined or configured threshold.

One condition for determining whether a grant is reserved for the transmission of pre-processed TBs is an RNTI value that may be used to scramble the CRC attached to the DCI indicating the grant.

One condition for determining whether a grant is reserved for the transmission of pre-processed TBs is a coreset and/or search space from which PDCCH carrying the DCI indicating the grant is decoded.

One condition for determining whether a grant is reserved for the transmission of pre-processed TBs is a size of the DCI indicating the grant.

One condition for determining whether a grant is reserved for the transmission of pre-processed TBs is a scheduling property of the DCI or any other suitable indication by DCI.

One condition for determining whether a grant is reserved for the transmission of pre-processed TBs is a value of a MCS field. For example, one or more values of the MCS field may indicate a modulation order but no target coding rate. If the grant is for initial transmission of a TB (e.g., WTRU did not receive PDCCH for the same TB), then the WTRU determines that the grant is reserved for the transmission of pre-processed TBs.

One condition for determining whether a grant is reserved for the transmission of pre-processed TBs is a type of grant, where the grant type may be determined based on at least one of the SCS (Sub-Carrier Spacing), the grant duration (e.g., in terms of ms, slots, subframes, any other suitable metric, or any combination thereof), the grant serving cell, the BWP (Bandwidth Part), whether the grant is configured by another grant, whether the grant is a dynamic grant, a priority index, a HARQ mode, or any combination thereof.

If the WTRU (e.g., any WTRU 102) determines that a grant is reserved for transmission of pre-processed TBs, then the WTRU may use following solutions for the encoding and multiplexing of TB(s) in the grant. These illustrative and non-limiting solutions are described for single codeword cases, but they may be extended to more than one codeword (e.g., for more than 4 spatial layers) without loss of generality.

In some embodiments, the WTRU may encode a single TB by determining the number of coded bits from the indicated modulation order and the number of symbols (resource elements) available for data in the grant.

In some embodiments, the WTRU may encode more than one TB by determining the number of coded bits for each TB from the indicated modulation order or from a number of resource elements available for data for each TB. The WTRU may allocate a number of resource elements available for data to each TB in proportion to the size of the TB, such that the corresponding coding rate is the same (or similar) for each TB.

In some embodiments, the WTRU may indicate the number and/or size(s) of each TB multiplexed in the resource as part of a UCI transmission.

In one method, the WTRU may perform LCP (e.g., allocation of data from different flows) in a simplified manner. In one example, the WTRU may execute a single operation to divide the grant across data flows with buffered bits, where the division may be uniform or may have discretely weighted components. The WTRU may perform this division before or after allocating resources in the grant for MAC CEs and/or MAC headers. The WTRU may set the weights of weighted components proportional to flow priority, e.g., where one LCH is assigned a weight of [(max(priorities)-LCH priority]/max(priorities), with max(priorities) representing the maximum priority among LCHs with buffered data. The weights of weighted components can alternatively be described as priority/max(priorities) or priority/(number of contending LCHs). In another example, the weights of weighted components can be assigned proportional to the WTRU's PBR and/or Bj level (e.g., LB(t)). The WTRU may, e.g., set the weight to PBR/sum(PBRs of contending LCHs), Bj/sum(Bjs of contending LCHs), or (Bj/PBR)/sum[(Bj/PBR)s of contending LCHs]. In one example, the weights can be set proportional to the amount of buffered bits, with or without the case of remaining time being less than a threshold (e.g., based on the possible presence of delay critical data); in this example, the weight for an LCH can be set to (amount of buffered bits in the LCH)/sum[(amount of buffered bits)s of contending LCHs].

After the division of bits (e.g., based on data flows, based on data units, based on any other criteria, or based on any combination thereof) within a grant, some bits (e.g., padding bits) may remain, e.g., when the LCHs that are allocated as parts of a grant are more than the amount of buffered bits. As a result, the WTRU may initially allocate all data to all LCHs, and may then continue padding bits at the end of the PDU. Instead of transmitting padding bits, the WTRU may transmit one or more MAC CEs (e.g., padding BSR/DSR, truncated BSR/DRS, a simplified BSR, a PHR, or any combination thereof), an indication about the remaining padding bits or the that there is remaining bits in the LCHs buffer, data from one or more LCHs, or any combination thereof. When transmitting data from one or more LCHs, e.g., the WTRU may allocate remaining space in the grant for data from the highest priority LCH with buffered data, and may (e.g., sequentially) work through lower-priority LCHs until the allocation of the grant is fully used up.

In one example, a simplified LCP procedure may be applied by the WTRU (e.g., any WTRU 102) based on sequential allocation of bits per flow until the allocation of the grant is fully used up. The WTRU may perform this simplified LCP procedure before or after allocating resources in the grant for MAC CEs and/or MAC headers, or the WTRU may reserve space for these parts prior to other data allocations. The simplified LCP may be based on a priority first allocation or a static priority allocation, e.g., as mentioned above.

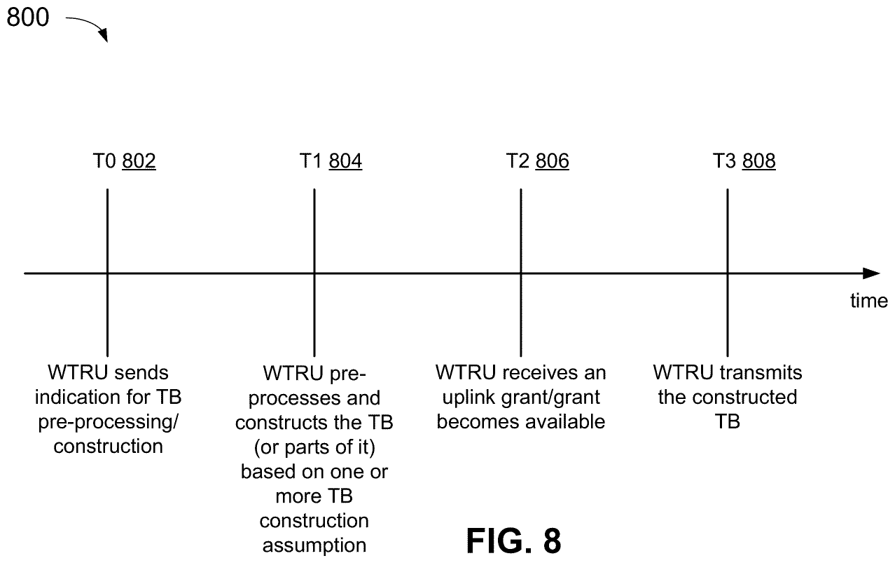

FIG. 8 shows an illustrative timing diagram 800 for TB construction according to some embodiments of this disclosure. For example, times T0 802, T1 804, T2 806, and T3 808 as shown in FIG. 8 may correspond to times T0, T1, T2, and T3 as described above in connection with steps 0, 1, and 2 for preprocessed TB construction.

As shown in FIG. 8, time progresses from left to right. That is, time T0 802 precedes time T1 804, which precedes time T2 806, which precedes time T3 808. At time T0 802, a WTRU (e.g., any WTRU 102) sends an indication for TB pre-processing (i.e., for constructing the TB prior to when it is explicitly needed). At time T1 804, the WTRU pre-processes and constructs the TB (or at least a portion of the TB) based on one or more TB construction assumption. The one or more TB construction assumption may be based on at least one of a transport block size (TBS), a quality of service (QoS) treatment policy, a UL traffic shaping policy, a subset of data flows associated with the TB, a logical channel prioritization (LCP), a minimum number of bits of the TBS to process, or a coding rate. At time T2 806, the WTRU receives an UL grant, or the UL grant otherwise becomes available (e.g., the UL grant may have been in a buffer). At time T3 808, the WTRU transmits the constructed TB. In between times T2 806 and T3 808, the WTRU may determine that an assumption signaled in the UL grant matches at least one of the one or more TB construction assumptions. For example, at least one assumption signaled in the UL grant may be the same as at least one TB construction assumption; that is, an assumption signaled in the UL grant may be a transport block size (TBS), a UL traffic shaping assumption/policy, a subset of involved data flows (e.g. a subset of logical channels (LCHs)), a minTBS bits that can be pre-processed, TB construction/LCP assumption, a coding rate, any other suitable information, or any combination thereof.

If the WTRU determines that there is a mismatch between assumptions of the UL grant and the one or more TB construction assumptions, then the WTRU may instead (e.g., at T3 808), divide a resource allocation of the UL grant proportional to at least one of a prioritized bit rate, an amount of data bits in a traffic shaping bucket of the WTRU, buffered data levels, or data flow priorities. The divided resource allocation of the UL grant may correspond to a reduced-complexity (e.g., compared to that of a typical approach, or one without preprocessing) TB construction. The reduced-complexity TB construction may be provided based on a single step bit allocation or based on a prioritized allocation, as described above in connection with the reduced-complexity TB construction.

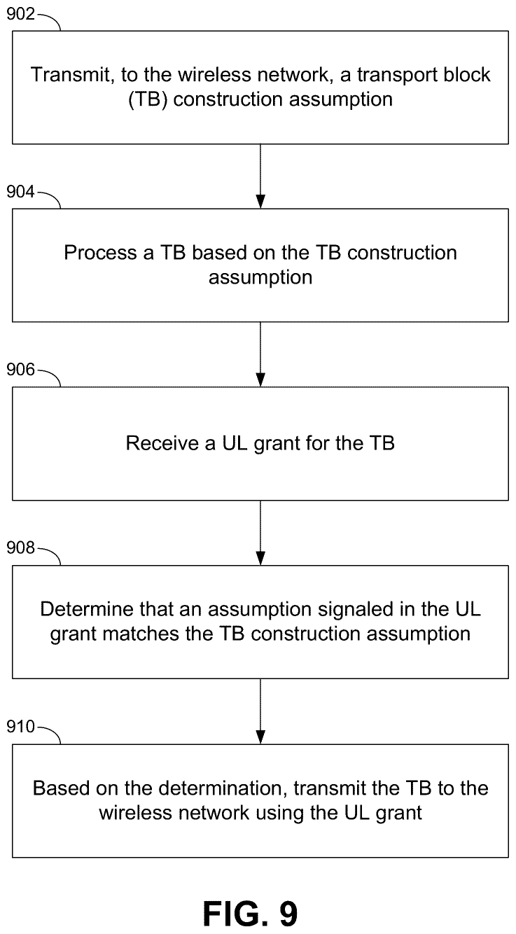

FIG. 9 is a flowchart of illustrative steps for TB construction according to one or more embodiments of this disclosure. The illustrative steps of FIG. 9 may be performed by any WTRU 102, any suitable WTRU in communication with a wireless network, or any other suitable device. At step 902, a WTRU may transmit a TB construction assumption to the wireless network. In some embodiments, the TB construction assumption is associated with UL data that is to arrive at the WTRU. For example, the TB construction assumption may include at least one of a transport block size (TBS), a quality of service (QoS) treatment policy, a UL traffic shaping policy, a subset of data flows associated with the TB, a logical channel prioritization (LCP), a minimum number of bits of the TBS to process, or a coding rate. In some embodiments, to transmit the TB construction assumption includes configuring one of a BSR or an SR to indicate the TB construction assumption.

At step 904, the WTRU may process a TB based on the TB construction assumption. In some embodiments, processing the TB based on the TB construction assumption includes processing the TB prior to receiving the UL grant (e.g., as occurs at step 906). In some embodiments, the WTRU may be configured to process the TB at semi-statically configured occasions (e.g., where semi-statically may mean that the occasions are preconfigured and are periodically reconfigured, but not necessarily changed, at any suitable interval). In some embodiments, the WTRU may be configured to process the TB in response to receiving the UL grant from the network (e.g., as occurs at step 906). In some embodiments, to process the TB includes processing at least a portion of the TB, where the portion is selected based on at least one of a subset off data types, a subset of logical channels (LCHs), or a subset of radio link controls (RLCs).

At step 906, the WTRU may receive a UL grant for the TB. For example, the UL grant may be associated with UL data that is to arrive at the WTRU.

At step 908, the WTRU may determine that an assumption signaled in the UL grant matches the TB construction assumption. The assumption may be signaled in downlink (DL) control information (DCI) associated with the UL grant (e.g., as received at step 906). The assumption signaled in the UL grant may, e.g., include any one or more of the details described in connection with the TB construction assumption that is transmitted at step 902. In some embodiments, determining that the assumption signaled in the UL grant matches the TB construction assumption includes determining that that a TBS of the UL grant is greater than or equal to a TBS of the TB as processed at step 904.

At step 910, based on the determination, the WTRU may transmit the TB to the wireless network using the UL grant.

In some embodiments, in connection with the illustrative steps shown in FIG. 9, the WTRU may also reserve a portion of a resource allocation of the UL grant for MAC CEs or MAC headers.

In some embodiments, in connection with the illustrative steps shown in FIG. 9, the WTRU may determine, at step 908, that an assumption signaled in the UL grant does not match the TB construction assumption (e.g., based on a TBS of the UL grant being less than a TBS of the TB processed at step 904). Accordingly, rather than proceeding to step 910, in response to a failure to determine that the assumption signaled in the UL grant matches the TB construction, the WTRU may divide a resource allocation of the UL grant proportional to at least one of a prioritized bit rate, an amount of data bits in a traffic shaping bucket of the WTRU, buffered data levels, or data flow priorities.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted systems are merely examples, and that in fact many other systems may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of systems or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”. The use of “a”, “an” and similar phrases are to be interpreted as “one or more” and “at least one”. Similarly, any term which ends with the suffix “(s)” is to be interpreted as “one or more” and “at least one”. The term “may” is to be interpreted as “may, for example”. A symbol “/” (e.g., forward slash) may be used herein to represent “and/or”, where, for example, “A/” may indicate “A and/or B”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke means-plus-function claim format, and any claim without the terms “means for” is not so intended.

What is claimed is:

1. A wireless transmit/receive unit (WTRU) that is in communication with a wireless network, the WTRU comprising a processor and a transceiver configured to:
transmit, to the wireless network, a transport block (TB) construction assumption, wherein the TB construction assumption is associated with uplink (UL) data that is to arrive at the WTRU;
process a TB based on the TB construction assumption;
receive a UL grant for the TB;
determine that an assumption signaled in the UL grant matches the TB construction assumption; and
based on the determination, transmit the TB to the wireless network using the UL grant.

2. The WTRU of claim 1, wherein the TB construction assumption comprises at least one of a transport block size (TBS), a quality of service (QoS) treatment policy, a UL traffic shaping policy, a subset of data flows associated with the TB, a logical channel prioritization (LCP), a minimum number of bits of the TBS to process, or a coding rate.

3. The WTRU of claim 1, wherein to process the TB based on the TB construction assumption comprises processing the TB prior to receiving the UL grant.

4. The WTRU of claim 1, wherein the assumption signaled in the UL grant comprises an assumption signaled in downlink (DL) control information (DCI) associated with the UL grant.

5. The WTRU of claim 1, wherein to transmit the TB construction assumption comprises configuring one of a buffered status report (BSR) or a status report (SR) to indicate the TB construction assumption.

6. The WTRU of claim 1, wherein the processor and the transceiver are further configured to process the TB at semi-statically configured occasions, or in response to receiving the UL grant from the wireless network.

7. The WTRU of claim 1, wherein to process the TB comprises processing at least a portion of the TB, wherein the portion is selected based on at least one of a subset off data types, a subset of logical channels (LCHs), or a subset of radio link controls (RLCs).

8. The WTRU of claim 1, wherein the processor and the transceiver are further configured to reserve a portion of a resource allocation of the UL grant for medium access control (MAC) control elements (CEs) or MAC headers.

9. The WTRU of claim 1, wherein to determine that the assumption signaled in the UL grant matches the TB construction assumption comprises determining that a TBS of the UL grant is greater than or equal to a TBS of the TB.

10. The WTRU of claim 1, wherein the processor and the transceiver are further configured to, in response to a failure to determine that the assumption signaled in the UL grant matches the TB construction, divide a resource allocation of the UL grant proportional to at least one of a prioritized bit rate, an amount of data bits in a traffic shaping bucket of the WTRU, buffered data levels, or data flow priorities.

11. A method performed by a wireless transmit/receive unit (WTRU) that is in communication with a wireless network, the WTRU comprising a processor and a transceiver, the method comprising:
transmitting, to the wireless network, a transport block (TB) construction assumption, wherein the TB construction assumption is associated with uplink (UL) data that is to arrive at the WTRU;
processing a TB based on the TB construction assumption;
receiving a UL grant for the TB;
determining that an assumption signaled in the UL grant matches the TB construction assumption; and
based on the determination, transmitting the TB to the wireless network using the UL grant.

12. The method of claim 11, wherein the TB construction assumption comprises at least one of a transport block size (TBS), a quality of service (QoS) treatment policy, a UL traffic shaping policy, a subset of data flows associated with the TB, a logical channel prioritization (LCP), a minimum number of bits of the TBS to process, or a coding rate.

13. The method of claim 11, wherein processing the TB based on the TB construction assumption comprises processing the TB prior to receiving the UL grant.

14. The method of claim 11, wherein the assumption signaled in the UL grant comprises an assumption signaled in downlink (DL) control information (DCI) associated with the UL grant.

15. The method of claim 11, wherein to transmit the TB construction assumption comprises configuring one of a buffered status report (BSR) or a status report (SR) to indicate the TB construction assumption.

16. The method of claim 11, further comprising processing the TB at semi-statically configured occasions, or in response to receiving the UL grant from the wireless network.

17. The method of claim 11, wherein processing the TB comprises processing at least a portion of the TB, wherein the portion is selected based on at least one of a subset off data types, a subset of logical channels (LCHs), or a subset of radio link controls (RLCs).

18. The method of claim 11, further comprising reserving a portion of a resource allocation of the UL grant for medium access control (MAC) control elements (CEs) or MAC headers.

19. The method of claim 11, wherein determining that the assumption signaled in the UL grant matches the TB construction assumption comprises determining that a TBS of the UL grant is greater than or equal to a TBS of the TB.

20. The method of claim 11, further comprising in response to a failure to determine that the assumption signaled in the UL grant matches the TB construction, dividing a resource allocation of the UL grant proportional to at least one of a prioritized bit rate, an amount of data bits in a traffic shaping bucket of the WTRU, buffered data levels, or data flow priorities.
